(19) United States
(12) Patent Application Publication
(10) Pub. No.: US 2026/0299169 A1
(43) Pub. Date: Oct. 1, 2026

(54) LIGHT TRAP SYSTEMS AND SURFACES

(71) Applicant: Welch Allyn, Inc., Skaneateles Falls, NY (US)

(72) Inventors: Vivian L. Hunter, Auburn, NY (US); Joshua F. Hess, Moravia, NY (US); Scott A. Martin, Camillus, NY (US)

(21) Appl. No.: 19/630,142

(22) Filed: Mar. 26, 2026

Related U.S. Application Data
(60) Provisional application No. 63/779,974, filed on Mar. 28, 2025.

(51) Int. Cl. G02B 1/10

(52) U.S. Cl. CPC G02B 1/10; G02B 2207/123

(57) ABSTRACT

A device including a body having a first surface to receive stray light within a housing of a device and a second surface opposite the first surface. The device includes a plurality of openings at the first surface to receive the stray light. The plurality of openings connected to one or more light paths within the body to terminate within the body or at the second surface to prevent the stray light from reflecting within the housing. The plurality of openings define channels that extend into the body to reflect received light to a distal end of the channel by reflecting off one or more surfaces within the body.

### CROSS REFERENCE TO RELATED APPLICATIONS

This application claims priority to U.S. Provisional Application No. 63/779,974, titled “LIGHT TRAP SYSTEMS AND SURFACES”, filed Mar. 28, 2025, which is hereby incorporated by reference in its entirety.

### TECHNICAL FIELD

This application is directed to light management such as devices and surfaces to trap and prevent reflection of incident light within a housing or other system. In particular, this application is directed to light management surfaces and devices to prevent reflection of stray beams of light within housings of medical devices that rely on image sensors and reflections of light.

### BACKGROUND

Diagnostic tools and systems that rely on light channels such as visible light and/or near infrared (NIR) typically have housings that limit or exclude a portion of incident light from interacting with the diagnostic sensors such as image sensors. Imaging devices such as cameras and other components also manage ambient and/or stray light within the housing of the device. Stray light is unintended, unwanted light that interferes with sensors in an optical system. Common examples of stray light may include sunbursts that speckle outdoor photos or an extra set of floating candles that appear in image data. Any unplanned light that reaches the image sensor and the final resulting image data is considered stray light, and can affect systems in a variety of applications such as medical equipment, diagnostic tools, augmented reality (AR), advanced driver-assistance systems (ADAS), microscopic research, and space-based imaging. If ambient or stray light is allowed to enter and reflect within the housing of devices and/or imaging devices then they may cause image anomalies such as ghost images or other artifacts in resulting image data that may result in inaccuracies in final analysis of the environment and/or subject.

Ambient and stray light can originate from outside of a device or may also originate from a light emitting component such as LEDs that emit visible or NIR light as part of a diagnostic tool or other image capture system. Such light emitting components need to be able to emit light for use in image capture and/or diagnostics without causing image artifacts due to stray light within the housing of the device. An optical system's resolution and contrast suffer as a result of stray light mixing with the intended signal. This can bring about image data that come up short of the freshness and detail required for various analyses and diagnoses.

The various examples of the present disclosure are directed toward overcoming one or more of the deficiencies noted above.

### SUMMARY

In an example of the present disclosure the systems and devices described herein relate to a stray light control device including: a planar body defined by a first plane and having a first surface with a first area to receive stray light within a housing of a device and a second surface opposite the first surface; a first set of louvers disposed adjacent the first surface, the first set of louvers: including a first plurality of angled baffles arranged in parallel with a first axis extending across the first plane, the first set of louvers dividing the first area into a first plurality of rectangular apertures; and having a first depth perpendicular to the first plane from the first surface to an intermediate position of the planar body and defining a second area at the intermediate position; and a second set of louvers disposed between the first set of louvers and the second surface, the second set of louvers: including a second plurality of angled baffles arranged perpendicular to the first axis and dividing the second area into a second plurality of rectangular apertures; and having a second depth perpendicular to the first plane from the intermediate position of the planar body to a second intermediate position and defining a third area at the second intermediate position.

In some aspects, the systems and devices described herein relate to a system including: a housing for an optically-based system; one or more optical components including an image sensor disposed within the housing; and a stray light control device including: a body defined by a first plane and having a first surface and a second surface opposite the first surface; a first set of louvers disposed adjacent the first surface, the first set of louvers including a first plurality of angled baffles arranged in parallel with a first axis; and a second set of louvers disposed between the first set of louvers and the second surface, the second set of louvers including a second plurality of angled baffles arranged perpendicular to the first axis.

In some aspects, the systems and devices described herein relate to a stray light control device including: a body defined by a first plane and having a first surface with a first area to receive stray light within a housing of a device and a second surface opposite the first surface; a plurality of openings defined in the first surface to divide the first area into a plurality of regions; and a plurality of channels defined within the body extending from the plurality of openings in the first surface; a channel of the plurality of channels: extending on a curved path within the body from the first surface towards the second surface; having a first cross-sectional area adjacent the first surface; and having a second cross-sectional area at a distal end of the channel, the second cross-sectional area less than the first cross-sectional area.

### BRIEF DESCRIPTION OF THE DRAWINGS

Features of the present disclosure, its nature, and various advantages, may be more apparent upon consideration of the following detailed description, taken in conjunction with the accompanying drawings.

FIG. 1 illustrates an example device such as a vision screening device used to perform one or more visual acuity exams or other analyses for a patient that implements stray light control devices within the housing thereof, in accordance with one or more examples.

FIG. 2 illustrates a first perspective view of an example stray light control device, in accordance with one or more examples.

FIG. 3 illustrates a second perspective view of the example stray light control device of FIG. 2, in accordance with one or more examples.

FIG. 4 illustrates top view of the example stray light control device of FIG. 2, in accordance with one or more examples.

FIG. 5 illustrates a third perspective view of the example stray light control device of FIG. 2, in accordance with one or more examples.

FIG. 6 illustrates a first section view of the example stray light control device of FIG. 4, in accordance with one or more examples.

FIG. 7 illustrates a second section view of the example stray light control device of FIG. 4, in accordance with one or more examples.

FIG. 8 illustrates an example stray light control device, in accordance with one or more examples.

FIG. 9 illustrates a first section view of the example stray light control device of FIG. 8, in accordance with one or more examples.

FIG. 10 illustrates a second section view of the example stray light control device of FIG. 8, in accordance with one or more examples.

### DETAILED DESCRIPTION

The present disclosure is directed to, in part, light trap devices and stray light control devices to prevent image artifacts in imaging systems of devices and components. An example system or device may include an imaging device used for medical diagnostics such as a vision screening device configured to perform one or more vision screening tests on a patient and to output the results of the vision screening test(s) to an operator of the device, such as a clinician or a physician's assistant.

The stray light control device may be part of an optical system that is used to manage light into and out of a device such as a diagnostic device. The optical system may include a light trap for the stray light control device that may be positioned with a housing of the device to trap stray light that may be present within the housing of the device. The stray light control device or light trap may include flat black paint and/or systems and devices as shown and described herein such as a textured structure. The stray light control device or light trap may be used to absorb and prevent reflections of stray light such as undesired reflections or other ambient light within a housing of the device.

The stray light control device may include a light baffling or light trapping structure or configuration or system that limits or reduces extraneous light that reflects within or is otherwise present in the housing of the device outside of an imaging axis (e.g., aligned with optical components used for imaging). The light baffling/light trapping structure thus helps assure that light originating external of the device and/or from within the device that is not incident at the image sensor of the imaging device is prevented from reflecting into the image sensor. Accordingly, the light aligned with the imaging components (e.g., optical axis) is allowed to travel into the housing and to the image sensor while other light from other sources or otherwise stray within the device is stopped from reaching the image sensor. Accordingly, the light baffling/light trapping structure of the stray light control device reduces extraneous light (such as sunlight glare, ambient light, emitted light within the housing, or the like) from glaring at or otherwise confusing image data gathered by the camera and its associated image processing system.

The stray light control device within the housing may have grooves or polymorph surfaces for catching or reducing scattered light. The stray light control device, which may be formed of light absorbing materials, may trap the extraneous or stray light and limit or preclude or reduce the stray light from reflecting towards the camera. The stray light control device may comprise dark or light absorbing baffles or ribs or columns or pits or depressions or the like (such as baffles or ribs formed of a dark or black plastic material or the like) to limit or reduce the amount of light that reflects off of the baffles. The use of casting, 3D printing, or other manufacturing techniques may enable complex geometries for the stray light control devices that may not be possible to form with other manufacturing techniques.

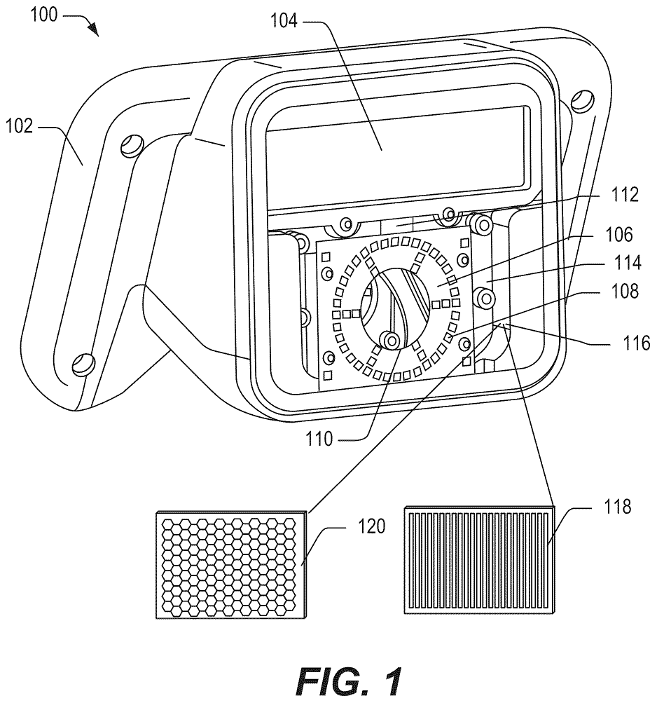

FIG. 1 illustrates an example device such as a vision screening device used to perform one or more visual acuity exams or other analyses for a patient that implements stray light control devices within the housing thereof, in accordance with one or more examples. FIG. 1 illustrates a perspective view of an example vision screening device 100 shown with a patient facing cover removed, showing a partial view of internal components stored within a housing 102 of the vision screening device 100, in accordance with one or more examples. The vision screening device 100 is illustrative of types of devices that may incorporate the stray light control devices as described herein. The vision screening device 100 includes an optical system with and image sensor and therefore may be an example of any suitable device or system that may need to control stray light within a housing. In addition to the housing 102, the vision screening device 100 includes a display 104 which serves as a patient-facing display to display digital objects such as symbols, pictures, letters, and other such information to a patient during an exam.

The vision screening device 100 used for the illustrative example herein may include light and imaging channels for near infrared (NIR) as well as white light. The combination of the imaging channels provides additional functionality as well as further screening exams to be performed. Emitters 108 for the NIR and the white light are mounted within the housing 102 of the vision screening device 100 and it is important for accurate results, when using the vision screening device 100, that stray light is prevented from reaching the imaging system (not depicted) of the vision screening device 100 and interfering with the results of the exam. For example, stray white light from an environment may interfere with a test being performed using the vision screening device 100 and may result in test results that are inaccurate or unreliable. Furthermore, stray light may result in image anomalies due to the unwanted light, as the imaging system of the vision screening device 100 and associated processing components may be configured to generate image data for exams and evaluation in the absence of such anomalies (which may cause false detections or inaccuracies in the results of the exams).

The emitters 108 of the vision screening device 100, such as LEDs, are mounted within a housing of the vision screening device 100 and structurally supported to provide positioning and alignment to an imaging system (e.g., an imaging path) for the vision screening device 100. Stray light control is needed to prevent light paths from interfering with each other and/or to prevent stray light from the environment form interfering with a designated light path.

In some examples, stray light may be controlled by means of stray light control devices 118 and 120 as well as absorbers such as filter glass or coatings or reflectors such as selective wavelength reflection. Though depicted with stray light control devices 118 and 120, in examples one or both of the stray light control devices may be used in a housing 102. The stray light control devices 118 and 120 may be arranged within the housing 102 and may also include light traps and/or other systems for preventing light from reflecting within the housing 102 of the vision screening device 100. Additionally, light returning from a test subject will also have to be controlled to ensure that once the reflected light enters the vision screening device 100, the light is directed to an intended destination (e.g., the imaging system) and not anywhere else within the housing 102. In addition, the ambient light from the environment also needs to be controlled to prevent image anomalies in the final results of the screening exams. Such anomalies or “ghost images” may be the result of ambient light, stray light, or uncontrolled reflected light. Because the LEDs are mounted within the housing 102 of the vision screening device 100 any stray light emitted by the LEDs must also be controlled to prevent interference and artifacts in images. The systems described here provide for light control systems within a vision screening device or other such system that uses image sensors and therefore relies on stray light being controlled to prevent interference with the image data.

With the cover removed, an interior of the housing 102 is depicted including an emitter array 106 that includes emitters 108. The emitter array 106 provides power from a power source of the vision screening device 100 to the emitters 108 and also provides for a processor of the vision screening device 100 to control the emitters 108 to selectively emit radiation towards the patient. The emitters 108 may include NIR emitters as well as visible light emitters (e.g., white light emitters) that project light out of the patient-facing side of the vision screening device 100 towards the patient. The emitters 108 may include LEDs and other sources of near infrared light as well as visible light or other types of emitted radiation that may be directed towards the patient and received back at the vision screening device 100 after reflecting off the patient.

The emitter array 106 defines an opening 110 at a center of the array of the emitters 108. The array of emitters 108 may share an optical axis and may direct light or radiate energy outwards toward the patient along near parallel directions. The reflected energy from the patient passes through the opening 110 to reach further internal components of the vision screening device 100 for sensing and detection.

The vision screening device 100 further includes a distance sensor 112. In FIG. 1 the distance sensor 112 is depicted positioned facing the patient and disposed vertically underneath the display 104. In some examples, the distance sensor 112 may be positioned within the housing 102 at any suitable position facing the patient-side of the housing 102 and oriented to face the patient when in use. The distance sensor 112 may include an ultrasonic sensor (and be positioned at the rear surface of the housing 102 with no glass between the distance sensor 112 and the patient, a millimeter wave radar sensor, a light-base sensor, or other such distance measuring sensor.

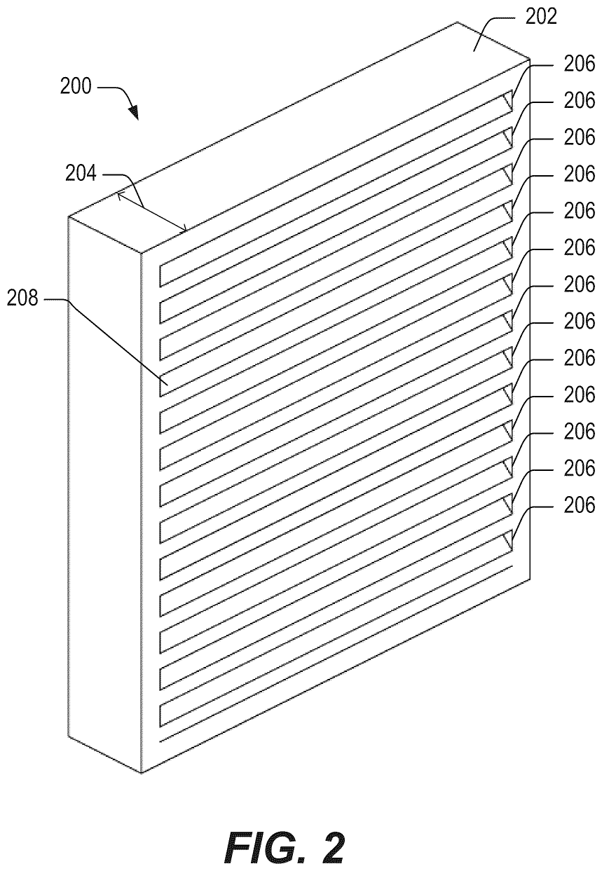

The vision screening device 100 is shown with a rigid chassis 114 that floats within the housing 102. The optical components of the vision screening device including the emitters, beam splitters, lenses, and filters are aligned and calibrated and secured to the rigid chassis 114. In examples, the emitters of the LED boards, lenses, image sensors are all aligned and centered for capturing image data. The rigid chassis 114 floats within the housing, and may be mounted to the housing through one or more shock absorbers, energy absorbing devices, and other such components to provide protection for the components in the event the vision screening device 100 is dropped. In examples, one or more of the components, such as the clinician-facing display and/or patient-facing display may be surface mounted to a skin of the housing 102. The housing 102 further includes one or more access ports for servicing the interior components, for example to calibrate or re-align the optical components. The vision screening device 100 also includes anti-reflective coatings 116 in addition to the stray light control devices 118 and 120 described in further detail with respect to FIGS. 2-10 herein in addition to light control means such as beam dumps, non-reflective paint, matte solder masks, and the like.

Within the housing 102, the imaging system may include a beamsplitter and/or other components to reflect, direct, and divert light into an imaging device. Remaining illumination directed through the beamsplitter or other such components impinges upon the stray light control devices 118 and 120 in order to prevent back reflection or glare produced within the housing 102. The stray light control means may include a light absorbing material such as strongly absorbing glass, black paint, or other suitable material and is configured to reduce the incidence of glare or back reflection in the housing 102 various light sources including the environment as well as the emitters 108 or reflective surfaces included as part of the imaging system.

The material forming the stray light control devices 118 and 120 may include a non-reflective material at a surface thereof such as a light absorbing coating. The stray light control devices 118 and 120 may be formed of a rigid material such as a metal or plastic and may be coated, for example with an anti-reflective coating, light absorbing coating, anodization, Vantablack coatings, or other such materials. Light absorbing coatings may include antireflective coatings, light absorbing coatings such as nanotube-based paints, and other such coatings configured to reduce or prevent reflections of stray light.

In the vision screening device 100, the stray light control device 118 is described in further detail with respect to FIGS. 2-7 herein. Though depicted herein with a rectangular perimeter and shape, the stray light control devices 118 and 120 may have any suitable perimeter or shape as needed within a particular housing 102. The stray light control device 118 includes a planar body defined by a first plane and having a first surface with a first area to receive stray light within the housing 102 and a second surface opposite the first surface. The stray light control device 118 includes sets of louvers with a first set of louvers disposed adjacent the first surface and a second set of louvers disposed within the planar body behind the first set of louvers at a first intermediate position within the body. The first set of louvers includes a first plurality of angled baffles arranged in parallel with a first axis extending across the first plane, the first set of louvers dividing the first area into a first plurality of rectangular apertures. The stray light control device 118 also includes a second set of louvers disposed between the first set of louvers and the second surface, the second set of louvers including a second plurality of angled baffles arranged perpendicular to the first axis and dividing the second area into a second plurality of rectangular apertures.

In some examples of the stray light control device 118 a distal end of a first louver of the first set of louvers is disposed, along an axis perpendicular to the first plane, beneath a proximal end of a second louver of the first set of louvers disposed adjacent to the first louver. The stray light control device 118 may also include a third set of louvers disposed at an intermediate position between the second set of louvers and the second surface, the third set of louvers including a third plurality of angled baffles arranged in parallel with the first axis. The stray light control device 118 may also include a fourth set of louvers disposed at a fourth position between the third set of louvers and the second surface, the fourth set of louvers including a fourth plurality of angled baffles arranged perpendicular to the first axis. In an example of the stray light control device 118, first surfaces of the first plurality of angled baffles and third surfaces of the third plurality of angled baffles are arranged in parallel and second surfaces of the second plurality of angled baffles and fourth surfaces of the fourth plurality of angled baffles are arranged in parallel. The stray light control device 118 may include or be coated with a light absorbing material or coating configured to break up light incident on the stray light control device or otherwise prevent reflections of the incident light.

The stray light control device 120 is an example of a stray light control device having a body defined by a first plane and having a first surface with a first area to receive stray light within a housing of a device and a second surface opposite the first surface. The stray light control device 120 includes a plurality of openings defined in the first surface to divide the first area into a plurality of regions and a plurality of channels defined within the body extending from the plurality of openings in the first surface. A channel of the plurality of channels extending on a curved path within the body from the first surface towards the second surface, having a first cross-sectional area adjacent the first surface, and having a second cross-sectional area at a distal end of the channel, the second cross-sectional area less than the first cross-sectional area. In the stray light control device 120 the plurality of openings each include a hexagonal perimeter at the first surface or other geometric shapes tessellated across the first surface or at least a portion of the first surface. The tessellation of geometric shapes provides for covering of the first surface or a portion thereof with no overlaps and no gaps between the shapes of the openings. The divider walls between the openings may include angled surfaces disposed at non-perpendicular angles to the first plane to prevent reflections of light off of a surface of the first surface back into the housing 102. Instead, the angled surfaces may reflect the incident light into the openings and into the channels of the stray light control device 120. The channels may terminate within the body between the first surface and the second surface and the channel may extend perpendicular to the first plane adjacent the first surface and terminate parallel to the first plane at the distal end of the channel. Examples of the stray light control devices 118 and 120 are described below with respect to FIGS. 2-10.

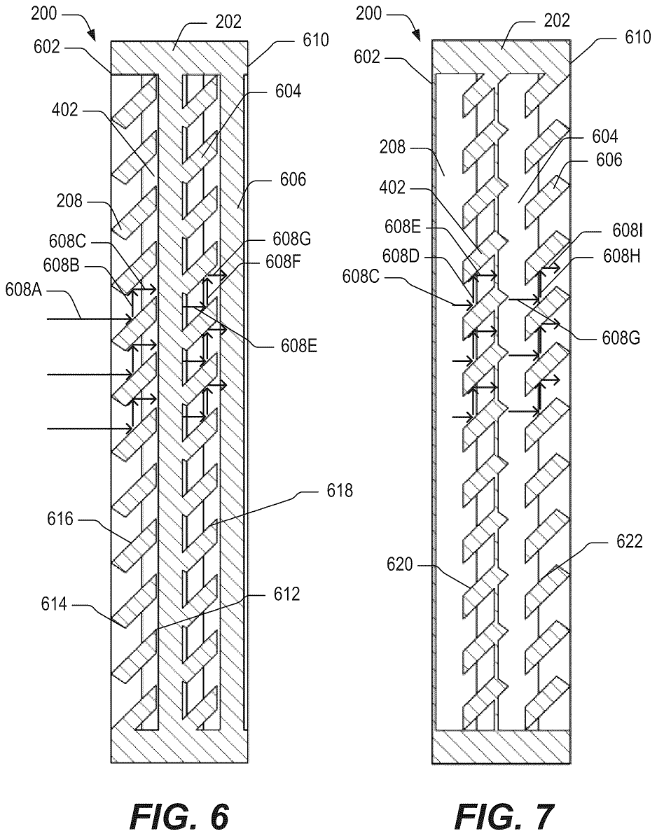

FIGS. 2-7 illustrate a stray light control device 200 which may be an example of the stray light control device 118 depicted in FIG. 1. FIG. 2 illustrates a first perspective view of an example stray light control device 200, in accordance with one or more examples. The stray light control device 200 is depicted with a body 202 having a thickness 204. The thickness 204 may be in a range of one millimeter to two or more centimeters. The thickness 204 allows for one or more layers of louvers, such as depicted in FIGS. 6-7. The body 202 of the stray light control device 200 defines a plurality of openings 206 covering a first area of the first surface of the body 202. The plurality of openings 206 are formed and defined by louvers 208. At the boundaries between the openings 206, the edges may have a surface that comes to a point edge or other non-flat surface such that light incident on the first surface may not be reflected off a portion of the first surface that is parallel with a plane that defined the body 202, for example as depicted with respect to FIGS. 6-7.

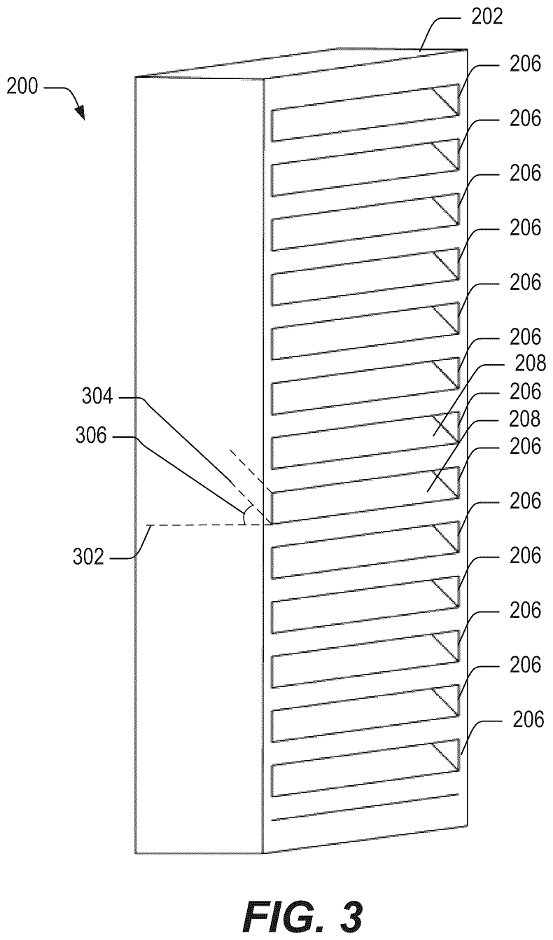

FIG. 3 illustrates a second perspective view of the example stray light control device 200 of FIG. 2, in accordance with one or more examples. As depicted in FIG. 3, the openings 206 are formed by a plurality of louvers 208. The louvers 208 define the openings 206 and provide a channel 304 for incident light to enter into the body 202 and trap the light. An axis 302 is shown perpendicular to the first surface and to the plant defining the body 202. The channel 304 is shown extending between the louvers 208 which may be parallel or non-parallel so as to cause the channel 304 to restrict as the channel 304 extends into the body 202. The channel 304 is shown at an angle 306 with respect to the first axis 302. The angle may be any suitable angle to cause incident light to reflect internally into the channel 304 and not reflect back out of the openings 206. In examples, the angle 306 may be in a range of between fifteen degrees and seventy-five degrees. The angle 306 may be defined by the geometry of the body 202 including the thickness 204, the size of the opening 206, the thickness of the louvers 208, and other such geometry. In some examples, the angle 306 may be selected such that a distal end of the louvers 208 is disposed beneath, along the direction of axis 302, the edge of an adjacent louver 208 such that light reflecting off the surface of the louver 208 reflects into an underside of the adjacent louver 208 as shown in FIGS. 6-7.

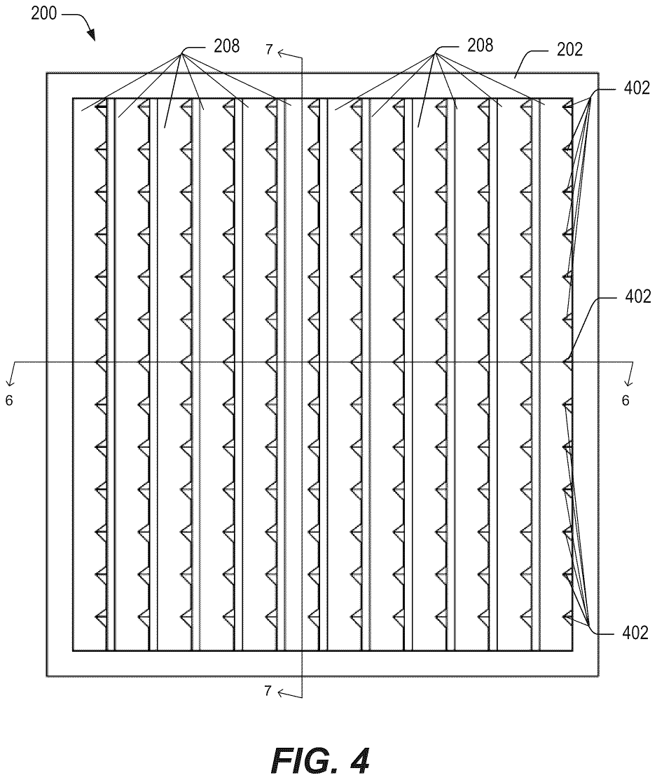

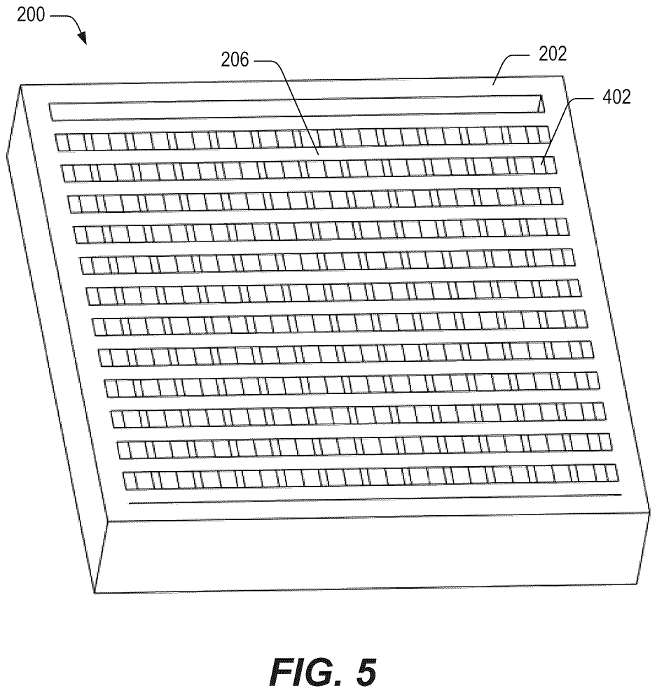

FIGS. 4 and 5 illustrate top and perspective views of the example stray light control device 200 of FIG. 2, in accordance with one or more examples. The stray light control device 200 is shown with the louvers 208 that define openings 206 adjacent the first surface of the body 202 and edges of a second set of louvers 402 are depicted within the body 202 of the stray light control device 200. The second set of louvers 402 may extend a depth into the body 202 from or adjacent a distal end of the louvers 208. The second set of louvers 402 are arranged perpendicular to the first set of louvers 208 such that light incident on the stray light control device 200 may reflect off a louver 208 and subsequently off a louver 402 to be trapped within the body 202 of the stray light control device 200. Cross sections taken at lines 5-5 and 6-6 are shown and described with respect to FIGS. 6 and 7 below.

FIG. 6 illustrates a first section view of the example stray light control device 200 of FIG. 4, in accordance with one or more examples. FIG. 7 illustrates a second section view taken perpendicular to the section view of FIG. 6 of the example stray light control device 200 of FIG. 4, in accordance with one or more examples. As depicted in FIG. 6, the stray light control device 200 includes a body 202 with first set of louvers 208 adjacent a first surface 602 of the body 202. Within the body 202 there are, from the first surface 602 and extending through the body 202 a first set of louvers 208, second set of louvers 402, third set of louvers 604, and a fourth set of louvers 606. Though depicted with four sets of louvers, the stray light control device 200 may include greater or less than four sets of louvers.

The stray light control device 200 includes sets of louvers with a first set of louvers 208 disposed adjacent the first surface 602 and a second set of louvers 402 disposed within the body 202 behind the first set of louvers. The first set of louvers 208 includes a first plurality of angled baffles arranged in parallel with each other and arrayed along a first axis extending across the first plane, the first set of louvers 208 dividing the first area of the first surface 602 into a first plurality of rectangular apertures or openings 206. The stray light control device 200 also includes a second set of louvers 402 disposed between the first set of louvers 208 and the second surface 610, the second set of louvers 402 including a second plurality of angled baffles arranged perpendicular to the first axis (and perpendicular to the first set of louvers 208) and dividing the second area into a second plurality of rectangular apertures.

As depicted in FIGS. 6 and 7 a distal end 612 of a first louver of the first set of louvers 208 is disposed, along an axis perpendicular to the first plane, beneath a proximal end 614 of a second louver of the first set of louvers 208 disposed adjacent to the first louver. The stray light control device 200 may also include a third set of louvers 604 disposed between the second set of louvers 402 and the second surface 610, the third set of louvers 604 including a third plurality of angled baffles arranged in parallel with the first axis and the first set of louvers 208. The stray light control device 200 may also include a fourth set of louvers 606 disposed between the third set of louvers 604 and the second surface 610, the fourth set of louvers 606 including a fourth plurality of angled baffles arranged perpendicular to the first axis. In an example of the stray light control device 200, first surfaces 616 of the first plurality of angled baffles and third surfaces 618 of the third plurality of angled baffles are arranged in parallel and second surfaces 620 of the second plurality of angled baffles and fourth surfaces 622 of the fourth plurality of angled baffles are arranged in parallel. The stray light control device 200 may include or be coated with a light absorbing material or coating configured to break up light incident on the stray light control device or otherwise prevent reflections of the incident light.

As depicted in FIGS. 6 and 7, incident light 608A may reflect off the first surface 616 as light 608B before reflecting off the underside of louver 208 as light 608C. The light 608C proceeds through the body 202 and reflects off the second louver 402 into light 608D before reflecting as light 608E off the underside of the second louver 402. The light ray then continues to reflect off the third louver 604 as light 608F and then the underside of third louver 604 as light 608G. Light 608G reflects off the fourth louver 606 as light 608H before reflecting off the underside of the fourth louver 606 as light 608I. The repeated reflections of the light within the body 202 may prevent the light from reflecting back out into the housing 102 and also reduces the intensity of the light as it reflects to provide additional light reduction within the housing.

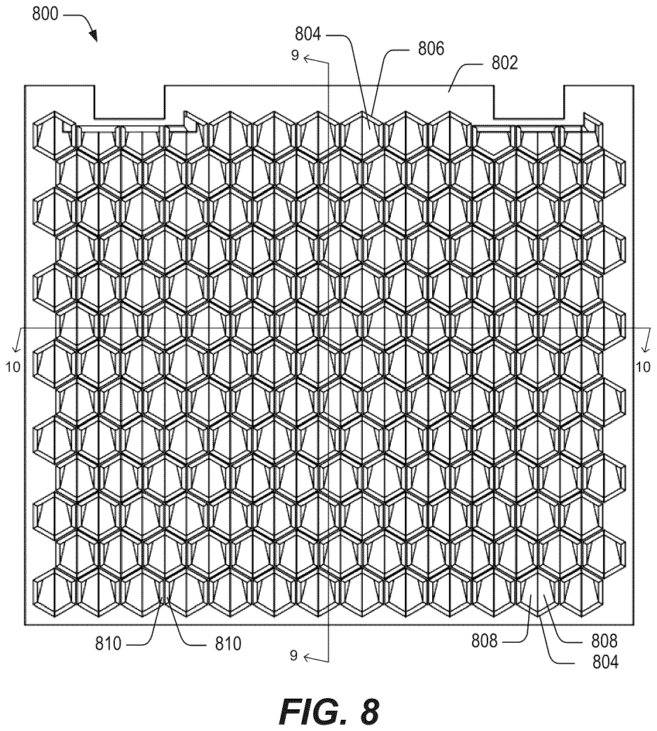

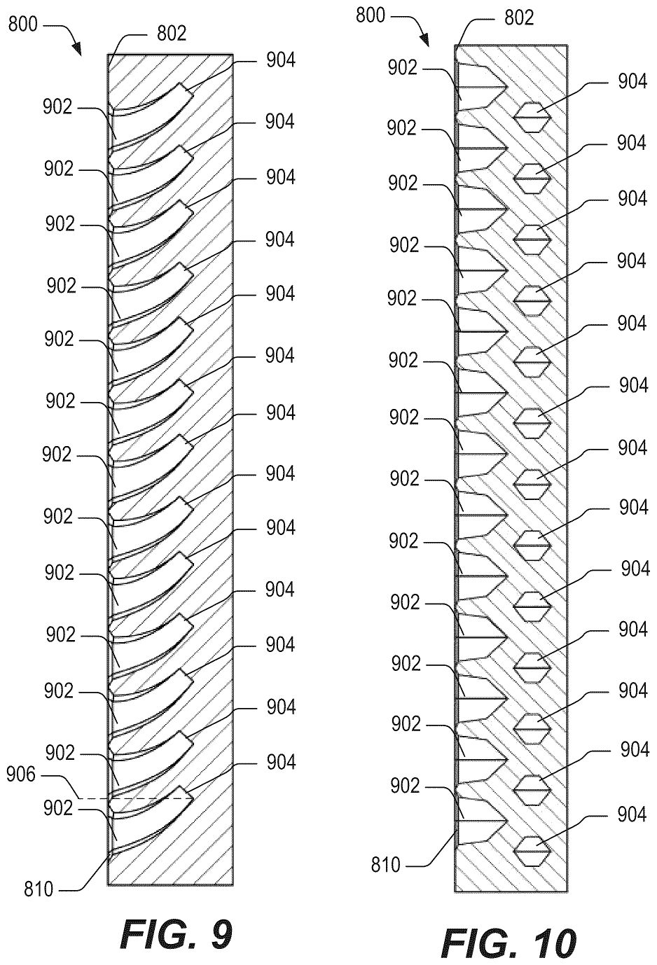

FIG. 8 illustrates an example stray light control device 800 such as the stray light control device 120 of FIG. 1, in accordance with one or more examples. The stray light control device 800 is an example of a stray light control device having a body defined by a first plane as shown in FIG. 8 and having a first surface 802 with a first area to receive stray light within a housing of a device and a second surface opposite the first surface. The stray light control device 800 includes a plurality of openings 804 defined in the first surface 802 to divide the first area into a plurality of regions and a plurality of channels defined within the body extending from the plurality of openings 804 in the first surface 802. A channel of the plurality of channels extending on a curved path within the body from the first surface towards the second surface, having a first cross-sectional area adjacent the first surface, and having a second cross-sectional area at a distal end of the channel, the second cross-sectional area less than the first cross-sectional area as depicted in FIGS. 9-10.

In the stray light control device 800 the plurality of openings each include a hexagonal perimeter at the first surface 802 though other geometric shapes tessellated across the first surface or at least a portion of the first surface 802. The tessellation of geometric shapes provides for covering of the first surface or a portion thereof with no overlaps and no gaps between the shapes of the openings 804. The perimeters 806 of the openings 804 may have hexagonal, square, rectangular, or other geometric shapes that may be tessellated across the first surface 802.

Within the openings 804 that define the channels, the interior includes facets 808 that reflect light incident on the openings deeper into the channels without escaping the openings 804. The facets may extend from the edges of the perimeters 806 such that the number of facets corresponds to the number of sides at the perimeter 806.

The divider walls 810 between the openings 804 may include angled surfaces disposed at non-perpendicular angles to the first plane to prevent reflections of light off of a surface of the first surface back into the housing of the device. Instead, the angled surfaces may reflect the incident light into the openings and into the channels of the stray light control device 800. The channels may terminate within the body between the first surface 802 and the second surface and the channel may extend perpendicular to the first plane adjacent the first surface and terminate parallel to the first plane at the distal end of the channel.

FIG. 9 illustrates a first section view of the example stray light control device 800 of FIG. 8, in accordance with one or more examples. The stray light control device 800 is depicted along the section line 9-9 depicted in FIG. 8. The stray light control device 800 is shown with channels 902 that extend from the openings 804 to distal ends 904. The channels 902 curve from the openings where the channels 902 are substantially perpendicular to the first surface 802 and at the distal end 904 the channel may be near or substantially parallel with the first surface 802. The curvature provides for light reflection to remain contained within the channel 902 without escaping the channel 902 or the opening 804. The curve of the channel 902 provides for the distal end 904 to extend beyond the perimeter 806 of the opening 804 as depicted with respect to line 906.

FIG. 10 illustrates a second section view of the example stray light control device 800 of FIG. 8, in accordance with one or more examples. The stray light control device 800 is depicted with the distal ends 904 shown underneath an edge of an adjacent row of channels 902. The structure provides for light that reflects into the channels 902 to be captured within the channel 902 and avoid light reflecting within the housing of a device. Though depicted with respect to FIGS. 8-10 with the channel 902 extending only a portion of the distance from the first surface 802 to the second surface, in some examples the channel 902 may extend through the body of the stray light control device 800. The channel 902 maintains the facets throughout the length of the channel, but the cross-sectional area decreases from the opening 804 to the distal end 904 to prevent light from escaping. The facets prevent light scattering as would occur with a rounded surface that would scatter light that may escape and be stray within a housing.

The terms parallel and perpendicular are broadly used herein to connote an arrangement of elements that approximate a zero-degree directional arrangement and a 90-degree directional arrangement, respectively, even if not arranged at exactly such angular values. Throughout the claims and specification items being substantially perpendicular may refer to elements that are within a first range of degrees of a 90-degree arrangement, for example up to and in excess of fifteen to twenty degrees away from the 90-degree arrangement. Additionally, items being substantially parallel may refer to elements that are within a second range of degrees of a zero-degree arrangement, for example up to and in excess of fifteen to twenty degrees away from the zero-degree arrangement.

The foregoing is merely illustrative of the principles of this disclosure and various modifications can be made by those skilled in the art without departing from the scope of this disclosure. The above-described examples are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process limitations (e.g., dimensions, configurations, components, process step order, etc.) can be made to further optimize the provided structures, devices and methods, as shown and described herein. In any event, the structures and devices, as well as the associated methods, described herein have many applications. Therefore, the disclosed subject matter should not be limited to any single example described herein, but rather should be construed in breadth and scope in accordance with the appended claims.

### EXAMPLE CLAUSES

The following paragraphs are provided to illustrate various aspects of the present disclosure:

A: A stray light control device comprising: a planar body defined by a first plane and having a first surface with a first area to receive stray light within a housing of a device and a second surface opposite the first surface; a first set of louvers disposed adjacent the first surface, the first set of louvers: including a first plurality of angled baffles arranged substantially parallel with a first axis extending across the first plane, the first set of louvers dividing the first area into a first plurality of apertures; and having a first depth substantially perpendicular to the first plane from the first surface to an intermediate position of the planar body and defining a second area at the intermediate position; and a second set of louvers disposed between the first set of louvers and the second surface, the second set of louvers: including a second plurality of angled baffles arranged substantially perpendicular to the first axis and dividing the second area into a second plurality of apertures; and having a second depth substantially perpendicular to the first plane from the intermediate position of the planar body to a second intermediate position and defining a third area at the second intermediate position.

B: The stray light control device of paragraph A, wherein a distal end of a first louver of the first set of louvers is disposed, along an axis substantially perpendicular to the first plane, beneath a proximal end of a second louver of the first set of louvers disposed adjacent to the first louver.

C: The stray light control device of any of paragraphs A-B, further comprising a third set of louvers disposed between the second set of louvers and the second surface, the third set of louvers: including a third plurality of angled baffles arranged substantially parallel with the first axis, the third set of louvers dividing the third area into a third plurality of apertures; and having a third depth substantially perpendicular to the first plane from the second intermediate position to a third intermediate position and defining a fourth area at the third intermediate position.

D: The stray light control device of paragraph C, further comprising a fourth set of louvers disposed between the third set of louvers and the second surface, the fourth set of louvers: including a fourth plurality of angled baffles arranged substantially perpendicular to the first axis, the fourth set of louvers dividing the fourth area into a fourth plurality of apertures; and having a fourth depth substantially perpendicular to the first plane from the third intermediate position to the second surface and defining a fifth area at the second surface.

E: The stray light control device of paragraph D, wherein: first surfaces of the first plurality of angled baffles and third surfaces of the third plurality of angled baffles are arranged substantially parallel; and second surfaces of the second plurality of angled baffles and fourth surfaces of the fourth plurality of angled baffles are arranged substantially parallel.

F: The stray light control device of any of paragraphs A-E, wherein the planar body, the first set of louvers, and the second set of louvers comprise a light absorbing material.

G: The stray light control device of any of paragraphs A-F, wherein the planar body, the first set of louvers, and the second set of louvers comprise a light absorbing coating.

H: A system comprising: a housing for an imaging system; one or more optical components including an image sensor disposed within the housing; and a stray light control device comprising: a body defined by a first plane and having a first surface and a second surface opposite the first surface; a first set of louvers disposed adjacent the first surface, the first set of louvers including a first plurality of angled baffles arranged substantially parallel with a first axis; and a second set of louvers disposed between the first set of louvers and the second surface, the second set of louvers including a second plurality of angled baffles arranged substantially perpendicular to the first axis.

I: The system of paragraph H, wherein the body, the first set of louvers, and the second set of louvers comprise a light absorbing coating.

J: The system of any of paragraphs H-I, wherein the body, the first set of louvers, and the second set of louvers comprise a light absorbing material.

K: The system of any of paragraphs H-J, wherein a distal end of a first louver of the first set of louvers is disposed, along an axis substantially perpendicular to the first plane, beneath a proximal end of a second louver of the first set of louvers disposed adjacent to the first louver.

L: The system of any of paragraphs H-K, further comprising a third set of louvers disposed between the second set of louvers and the second surface, the third set of louvers including a third plurality of angled baffles arranged substantially parallel with the first axis.

M: The system of paragraph L, further comprising a fourth set of louvers disposed between the third set of louvers and the second surface, the fourth set of louvers including a fourth plurality of angled baffles arranged substantially perpendicular to the first axis.

N: The system of paragraph M, wherein: first surfaces of the first plurality of angled baffles and third surfaces of the third plurality of angled baffles are arranged substantially parallel; and second surfaces of the second plurality of angled baffles and fourth surfaces of the fourth plurality of angled baffles are arranged substantially parallel.

O: A stray light control device comprising: a body defined by a first plane and having a first surface with a first area to receive stray light within a housing of a device and a second surface opposite the first surface; a plurality of openings defined in the first surface to divide the first area into a plurality of regions; and a plurality of channels defined within the body extending from the plurality of openings in the first surface; a channel of the plurality of channels: extending on a curved path within the body from the first surface towards the second surface; having a first cross-sectional area adjacent the first surface; and having a second cross-sectional area at a distal end of the channel, the second cross-sectional area less than the first cross-sectional area.

P: The stray light control device of paragraph O, wherein the plurality of openings each comprise a hexagonal perimeter at the first surface.

Q: The stray light control device of any of paragraphs O-P, wherein the plurality of openings each comprise geometric shapes tessellated across the first surface.

R: The stray light control device of any of paragraphs O-Q, wherein divider walls between the plurality of openings comprise angled surfaces disposed at non-perpendicular angles to the first plane.

S: The stray light control device of any of paragraphs O-R, wherein the channel of the plurality of channels terminates within the body between the first surface and the second surface.

T: The stray light control device of any of paragraphs O-S, wherein the channel: extends substantially perpendicular to the first plane adjacent the first surface; and terminates substantially parallel to the first plane at the distal end of the channel.

What is claimed is:

1. A stray light control device comprising:
a planar body defined by a first plane and having a first surface with a first area to receive stray light within a housing of a device and a second surface opposite the first surface;
a first set of louvers disposed adjacent the first surface, the first set of louvers:
including a first plurality of angled baffles arranged substantially parallel with a first axis extending across the first plane, the first set of louvers dividing the first area into a first plurality of apertures; and
having a first depth substantially perpendicular to the first plane from the first surface to an intermediate position of the planar body and defining a second area at the intermediate position; and
a second set of louvers disposed between the first set of louvers and the second surface, the second set of louvers:
including a second plurality of angled baffles arranged substantially perpendicular to the first axis and dividing the second area into a second plurality of apertures; and
having a second depth substantially perpendicular to the first plane from the intermediate position of the planar body to a second intermediate position and defining a third area at the second intermediate position.

2. The stray light control device of claim 1, wherein a distal end of a first louver of the first set of louvers is disposed, along an axis substantially perpendicular to the first plane, beneath a proximal end of a second louver of the first set of louvers disposed adjacent to the first louver.

3. The stray light control device of claim 1, further comprising a third set of louvers disposed between the second set of louvers and the second surface, the third set of louvers:
including a third plurality of angled baffles arranged substantially parallel with the first axis, the third set of louvers dividing the third area into a third plurality of apertures; and
having a third depth substantially perpendicular to the first plane from the second intermediate position to a third intermediate position and defining a fourth area at the third intermediate position.

4. The stray light control device of claim 3, further comprising a fourth set of louvers disposed between the third set of louvers and the second surface, the fourth set of louvers:
including a fourth plurality of angled baffles arranged substantially perpendicular to the first axis, the fourth set of louvers dividing the fourth area into a fourth plurality of apertures; and
having a fourth depth substantially perpendicular to the first plane from the third intermediate position to the second surface and defining a fifth area at the second surface.

5. The stray light control device of claim 4, wherein:
first surfaces of the first plurality of angled baffles and third surfaces of the third plurality of angled baffles are arranged substantially parallel; and
second surfaces of the second plurality of angled baffles and fourth surfaces of the fourth plurality of angled baffles are arranged substantially parallel.

6. The stray light control device of claim 1, wherein the planar body, the first set of louvers, and the second set of louvers comprise a light absorbing material.

7. The stray light control device of claim 1, wherein the planar body, the first set of louvers, and the second set of louvers comprise a light absorbing coating.

8. A system comprising:
a housing for an imaging system;
one or more optical components including an image sensor disposed within the housing; and
a stray light control device comprising:
a body defined by a first plane and having a first surface and a second surface opposite the first surface;
a first set of louvers disposed adjacent the first surface, the first set of louvers including a first plurality of angled baffles arranged substantially parallel with a first axis; and
a second set of louvers disposed between the first set of louvers and the second surface, the second set of louvers including a second plurality of angled baffles arranged substantially perpendicular to the first axis.

9. The system of claim 8, wherein the body, the first set of louvers, and the second set of louvers comprise a light absorbing coating.

10. The system of claim 8, wherein the body, the first set of louvers, and the second set of louvers comprise a light absorbing material.

11. The system of claim 8, wherein a distal end of a first louver of the first set of louvers is disposed, along an axis substantially perpendicular to the first plane, beneath a proximal end of a second louver of the first set of louvers disposed adjacent to the first louver.

12. The system of claim 8, further comprising a third set of louvers disposed between the second set of louvers and the second surface, the third set of louvers including a third plurality of angled baffles arranged substantially parallel with the first axis.

13. The system of claim 12, further comprising a fourth set of louvers disposed between the third set of louvers and the second surface, the fourth set of louvers including a fourth plurality of angled baffles arranged substantially perpendicular to the first axis.

14. The system of claim 13, wherein:
first surfaces of the first plurality of angled baffles and third surfaces of the third plurality of angled baffles are arranged substantially parallel; and
second surfaces of the second plurality of angled baffles and fourth surfaces of the fourth plurality of angled baffles are arranged substantially parallel.

15. A stray light control device comprising:
a body defined by a first plane and having a first surface with a first area to receive stray light within a housing of a device and a second surface opposite the first surface;
a plurality of openings defined in the first surface to divide the first area into a plurality of regions; and
a plurality of channels defined within the body extending from the plurality of openings in the first surface; a channel of the plurality of channels:
extending on a curved path within the body from the first surface towards the second surface;
having a first cross-sectional area adjacent the first surface; and
having a second cross-sectional area at a distal end of the channel, the second cross-sectional area less than the first cross-sectional area.

16. The stray light control device of claim 15, wherein the plurality of openings each comprise a hexagonal perimeter at the first surface.

17. The stray light control device of claim 15, wherein the plurality of openings each comprise geometric shapes tessellated across the first surface.

18. The stray light control device of claim 15, wherein divider walls between the plurality of openings comprise angled surfaces disposed at non-perpendicular angles to the first plane.

19. The stray light control device of claim 15, wherein the channel of the plurality of channels terminates within the body between the first surface and the second surface.

20. The stray light control device of claim 15, wherein the channel:
extends substantially perpendicular to the first plane adjacent the first surface; and
terminates substantially parallel to the first plane at the distal end of the channel.
